(19) United States
(12) Patent Application Publication
(10) Pub. No.: US 2026/0318362 A1
(43) Pub. Date: Oct. 15, 2026

(54) Bearing

(71) Applicant: Aktiebolaget SKF, Goteborg (SE)

(72) Inventors: Hongyuan AN, Shangai (CN); Shuran FAN, Kunming (CN); Yawei SHAO, Shanghai (CN)

(21) Appl. No.: 19/637,244

(22) Filed: Apr. 2, 2026

(30) Foreign Application Priority Data
Apr. 10, 2025 (CN) 202510449352.3

(51) Int. Cl. F16C 41/00

(52) U.S. Cl. CPC F16C 41/00; F16C 2220/04; F16C 2233/00

(57) ABSTRACT

A bearing has an outer ring and an inner ring. At least one of the outer ring or the inner ring is overmolded with connecting material. The bearing includes a sensor. At least a portion of the sensor is overmolded in the connecting material. Compared to the prior art, the present disclosure makes it possible to connect the sensor to the bearing by a simpler and reliable means, not only increasing the robustness of the connection but also reducing costs. Furthermore, the overmolding means of the present disclosure does not require the addition of extra connecting parts and does not require the provision of additional space for mounting the sensor, so that a more compact structure can be obtained.

### CROSS-REFERENCE TO RELATED APPLICATION

This application claims priority to Chinese Patent Application No. 202510449352.3, filed Apr. 10, 2025, the entirety of which is hereby incorporated by reference.

### FIELD

The present disclosure relates to a bearing, in particular to a bearing integrated with sensors.

### BACKGROUND

Bearings are widely used in a variety of equipment. Because bearings are the key moving parts of equipment, the working status of bearings plays a crucial role in the performance of equipment. Working conditions of the bearing comprises various aspects, such as bearing temperature, bearing vibration, raceway condition, cage gesture, lubricant condition, etc. If these conditions can be detected in time, health status of the bearing can be judged early and interventions can be taken accordingly.

Measures have been provided in the art for real-time detection of different operating conditions of a bearing. For example, one prior art detects some operating parameters of the bearing by integrating a sensor into the cage. Another prior art proposes machining a groove in a bearing component (such as the outer ring or the inner ring) and embedding a sensor in the groove by means of interference fit. Further prior art proposes mounting a sensor to the outer circumference of the bearing by means of additional fixing means.

However, these prior art technologies all have problems such as poor reliability of the installation structure, limited detection targets, high installation costs, inconvenience of installation, and large space occupation.

### SUMMARY

In view of the above-mentioned problems and needs, the present disclosure provides a new technical solution, which solves the above problems and brings other technical effects by adopting the following technical features.

The present disclosure provides a bearing comprising: an outer ring and an inner ring, wherein at least one of the outer ring or the inner ring is overmolded with connecting material; a sensor, at least a portion of which is overmolded in the connecting material.

Compared to the prior art, the present disclosure makes it possible to connect the sensor to the bearing by a simpler and reliable means, not only increasing the robustness of the connection but also reducing costs. Furthermore, the overmolding means of the present disclosure does not require the addition of extra connecting parts and does not require the provision of additional space for mounting the sensor, so that a more compact structure can be obtained.

### BRIEF DESCRIPTION OF THE DRAWINGS

FIG. 1 is a schematic cross-sectional view of a bearing according to a preferable embodiment of the present disclosure;

FIG. 2 is a front view and a partial enlarged view of part A of the bearing according to the preferable embodiment of the present disclosure.

### DETAILED DESCRIPTION

In order to make the purpose, technical solutions and advantages of the technical solutions of the present disclosure clearer, the technical solutions of the embodiments of the present disclosure will be clearly and completely described below with reference to the accompanying drawings of specific embodiments of the present disclosure. The same reference numbers in the drawings represent the same parts. It should be noted that the described embodiments are some, not all, of the embodiments of the present disclosure. Based on the described embodiments of the present disclosure, all other embodiments obtained by those of ordinary skill in the art without creative efforts fall within the scope of protection of the present disclosure.

Possible implementations within the scope of protection of the present disclosure may have fewer components than the embodiments illustrated in the Figs., have other components not illustrated in the Figs., different components, differently arranged components or differently connected components, etc. Furthermore, two or more components in the Figs. may be implemented within a single component, or a single component shown in the Figs. may be implemented as multiple separate components.

Unless otherwise defined, technical or scientific terms used herein shall have their ordinary meaning as understood by a person of ordinary skill in the art to which this disclosure belongs. The terms "first", "second" and similar words used in the specification and claims of this disclosure do not indicate any order, quantity or importance, but are only used to distinguish different components. When the number of components is not stated, the number of components can be one or more; likewise, words such as "a," "the," "said," and similar words do not necessarily indicate a quantitative limitation. Words such as "include" or "comprise" mean that the elements or items appearing before the word include the elements or items listed after the word and their equivalents, without excluding other elements or items. Words such as "installation", "setting", "connection" or "connection" are not limited to physical or mechanical installation, setting, and connection, but may include electrical installation, setting, and connection, whether direct or indirect. "Up", "down", "left", "right", etc. are only used to represent the relative orientation relationship when the device is used or the orientation relationship shown in the drawings. When the absolute position of the described object changes, the relative position Relationships may also change accordingly.

For ease of explanation, the direction of the rotational axis of the bearing is referred to herein as the axial direction, and the direction perpendicular to the axial direction is referred to as the radial direction. The term "inward/inner" means along towards the inside of the bearing, and conversely, the term "outward/outer" means towards the outside of the bearing.

The bearing according to the present disclosure is described below with reference to the accompanying drawings.

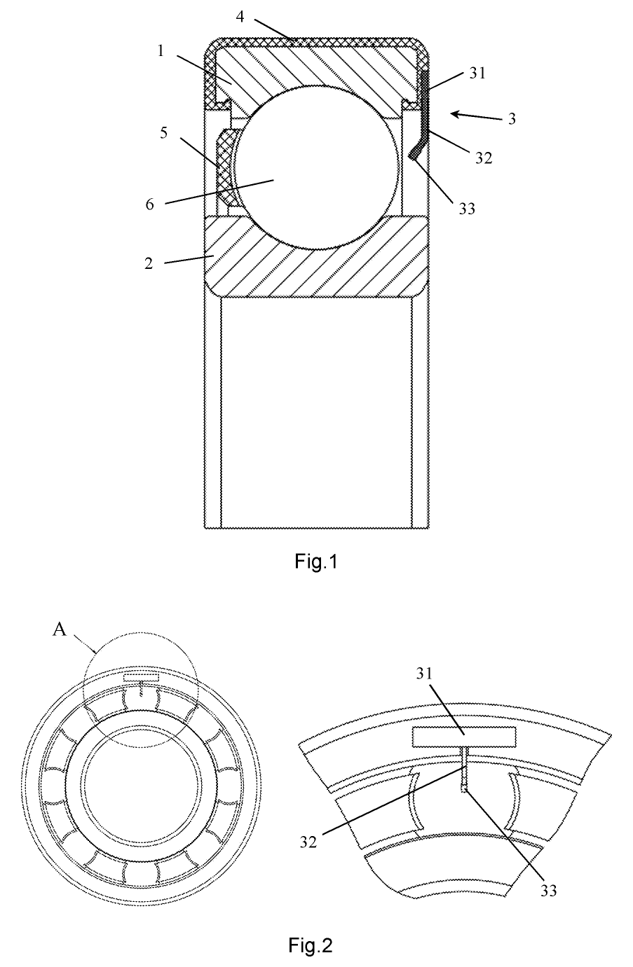

As shown in FIG. 1, a bearing according to a preferable embodiment of the present disclosure comprises: an outer ring 1, an inner ring 2 and a sensor 3. The outer ring 1 is overmolded with connecting material 4, and at least part of the sensor 3 is also overmolded in said connecting material 4.

Compared to the prior art, the present disclosure makes it possible to connect the sensor to the bearing by a simpler and reliable means, not only increasing the robustness of the connection but also reducing costs. Furthermore, the overmolding means of the present disclosure does not require addition of extra connecting parts and does not require provision of additional space for mounting the sensor, so that a more compact structure can be obtained.

It should be understood that the connecting material may have many options, as long as it can form a strong overmolded connection with the outer ring 1 and the sensor 3. For example, the connecting material 4 may be insulating material, such as rubber, resin, etc. Using insulating materials as the connecting material not only increases the electrical corrosion resistance of the bearing, but also brings other beneficial effects (described below).

The present disclosure can be applied to the connection between various types of sensors and bearings.

For example, the sensor 3 may be a vision sensor having a sensor body 31 and a camera 33. The camera 33 extends from the sensor body 31 and has a field of view toward the area to be sensed in the bearing. Preferably, according to the orientation of the camera shown in FIGS. 1-2, the area to be sensed can cover the raceway of the inner ring 2, so that the raceway can be imaged to obtain information about wear of the raceway, color change of the raceway, etc., which can be used to further evaluate current status of the bearing.

Although not shown, according to other preferable embodiments of the present disclosure, the area to be sensed may cover at least one of the raceway of the outer ring 1, the cage 5, and the rolling elements 6, so that wear and tear of the raceway of the outer ring can be monitored. Color changes, cage gesture, rolling elements status, lubricant status around rolling elements, etc. are visually sensed.

In the prior art, due to limitations in the installation location and installation method of the sensor, it is generally difficult to apply a sensor that can effectively and accurately visually sense the internal structure of the bearing such as the raceway of the outer ring/inner ring for bearing application. However, visual sensing of the internal structure of the bearing has an irreplaceable advantage and necessity compared to sensing of other parameters or conditions of the bearing, such as temperature, vibration, noise, etc., since some bearing problems can only be discovered and dealt with early through visual sensing. By the sensor installation method as described above, the present disclosure realizes integration of the visual sensor on the bearing in a simple manner, so that the camera can be brought as close as possible to the area that needs to be sensed, to achieve close-range visual imaging.

Further preferably, the vision sensor 3 also has an adjusting member 32 disposed between the sensor body 31 and the camera 33, so that the field of view of the camera 33 can be adjusted by adjusting the adjusting member 32. That is to say, the present disclosure can change the field of view of the camera according to actual needs, thereby changing the target or area to be sensed, so that different targets or areas can be sensed through one sensor without adding new sensors. For example, in the state shown in FIGS. 1-2, the camera 33 visually senses the raceway of the inner ring 2; according to a new sensing need, by adjusting the field of view of the camera 33 upward, the rolling elements 6, the claws of the cage 5 (not shown in the figures), and even the raceway of the outer ring 1 can be visually sensed. In addition, the camera 33 may also have a focus adjustment function to visually sense sites of interest at different distances within the field of view.

In particular, the adjusting member 32 may be, for example, a deformable sleeve (not shown), which may be, for example, a metal hose. The transmission line between the sensor body 31 and the camera 33 can be disposed in the deformable sleeve, so that the field of view of the camera 33 can be changed by manually bending the deformable sleeve, to perform visual sensing for different areas to be sensed. In addition, in order to adapt to the working environment and working requirements of the bearing, the deformable sleeve preferably has at least one of wear resistance, corrosion resistance or high temperature resistance.

According to another alternative embodiment, the adjusting member 32 may be a wire (not shown) wound around the transmission line between the sensor body 31 and the camera 33. After the wire is wound, the field of view of the camera 33 can also be changed by manual bending. The wire may be, for example, a metal wire, and preferably the wire has at least one of wear resistance, corrosion resistance or high temperature resistance, and may be, for example, a high density tungsten wire.

According to a preferable embodiment, the vision sensor 3 may also include an illuminator (not shown), such as an LED light, which can emit illumination light toward the area to be sensed to enhance the visual sensing effect. Preferably, the illuminator can be integrated in the camera 33, for example can be arranged next to the camera 33, so that the light can follow the camera's field of view. It is also preferable that the illuminator may be independent of the camera 33, and the illuminator may have another adjusting member arranged around wires of the illuminator, to adjust the illumination range of the illuminator, that is, the illuminator can have a separate adjustability.

According to another preferable embodiment of the present disclosure, not shown, the sensor 3 may be an infrared temperature sensor having a sensor body and a photodetector head (not shown). Similar to the vision sensor described in FIG. 1, the photodetector head of the infrared temperature sensor may extend from the sensor body and be positioned toward the area to be sensed in the bearing, for example, for the outer ring raceway, the inner ring raceway, the rolling element, and the parts of interest on the cage for non-contact temperature sensing.

Preferably, and similar to the preferable embodiment of FIG. 1, the infrared temperature sensor may also have an adjusting member disposed around the transmission line between the sensor body and the photodetector head, so that the sensing position of the photodetector head is adjusted by adjusting the adjusting member. Preferably, the adjusting member may be a deformable sleeve, and the transmission line is disposed in the deformable sleeve; and preferably, the deformable sleeve may have at least one of wear resistance, corrosion resistance or high temperature resistance. Alternatively, the adjusting member may be a wire wound around the transmission line; and preferably, the wire has at least one of wear resistance, corrosion resistance or high temperature resistance, and may be, for example, a high-density tungsten wire.

According to yet another preferable embodiment of the present disclosure, not shown, the sensor 3 may be a contact sensor. Preferably, the contact sensor may have a sensing component in direct contact with at least one of the outer ring 1 or the inner ring 2. Preferably, the contact sensor 3 may be a contact temperature sensor 3 or a contact vibration sensor 3, so that the temperature or vibration of the outer ring/inner ring can be directly sensed.

Preferably, with a sensor configuration as previously described, the sensor 3 can be a multi-function sensor that can be combined into multiple sensing functions to achieve comprehensive monitoring of the bearing operating conditions in a more intensive and cost-effective manner, such as monitoring raceway temperature and vibration conditions simultaneously, or capturing changes of lubricant conditions through visual sensors, etc. For example, the multifunctional sensor has at least two functions of temperature sensing, vibration sensing, and visual imaging.

In addition, the present disclosure also provides that the sensor body 31 of the sensor may also include a wireless communication module for transmitting sensing signals, thereby avoiding the structural complexity and installation inconvenience caused by wired transmission of sensing signals. Furthermore, in order to adapt to this type of sensor that wirelessly transmits sensing signals, the present disclosure also proposes to set the connecting material 4 as an insulating material and separate the sensor body 31 from the outer ring 1 by the insulating material, thereby reducing the interference electromagnetic fields to the signal transmission antenna caused by the outer ring 1 made by metal, preventing the metal outer ring from affecting the range and stability of signal transmission.

Preferably, the sensor body 31 of the sensor 3 may also have an energy harvester and a rechargeable battery connected to the energy harvester. The energy harvester may be configured to be one of an electromagnetic energy harvester, a wireless radio frequency energy harvester, a piezoelectric energy harvester, a thermal energy harvester, or other suitable wireless energy harvester. The energy harvester is configured to supply electrical energy to the rechargeable battery so that the rechargeable battery can be charged, thereby ensuring that the sensor senses the bearing without interruption for a long time and avoiding the inconvenience of frequent battery replacement.

The rechargeable battery is also configured to supply power to the power-consuming components of said sensor 3, such as the camera, the LED light, the wireless communication module, etc. as previously described. Further preferably, the sensor body 31 of the sensor 3 also has a backup battery to supply power to the power-consuming components of the sensor 3 when the rechargeable battery is out of power or is malfunctioning.

According to the preferable embodiment of the present disclosure, the sensor 3 may be flexibly arranged at any suitable position on the outer ring of the bearing. As shown in FIGS. 1-2, the sensor 3 is overmolded on the right axial end face of the outer ring 1. However, it should be understood that in order to adapt to different sensing needs or bearing installation space conditions, etc., the sensor 3 may be overmolded on the left axial end surface of the outer ring 1, or the sensor 3 may be overmolded on the outer peripheral face of the outer ring 1.

Further preferably, the outer ring 1 may include a groove for housing the sensor body 31 of the sensor 3. This is particularly advantageous when the sensor body 31 is larger in size, so that after overmolding the sensor 3 by the connecting material, the size of the bearing is not significantly increased, to obtain a more compact appearance.

Finally, those skilled in the art will understand that. in the preferable embodiment shown in the figures, the sensor 3 is overmolded onto the outer ring 1, however, depending on the specific structure and detection requirements for a bearing, the sensor may be overmolded onto the inner ring, and other connection structures, the adjusting member, the illumination member, etc. may be equally applied to embodiments in which the sensor is overmolded on the inner ring. Moreover, in case more parameter, more detailed sensing for the bearing is required, it is even possible to overmold multiple sensors at suitable locations of the outer ring and/or the inner ring. Therefore, the present disclosure proposes to overmold the sensor onto at least one of the outer ring or the inner ring.

The exemplary embodiments of the present disclosure have been described in detail above with reference to preferable embodiments. However, those skilled in the art will understand that various modifications and modifications can be made to the above specific embodiments without departing from the concept of the present disclosure. Modifications, and various technical features and structures proposed in the present disclosure can be made in various combinations without exceeding the scope of protection of the present disclosure, which is determined by the appended claims.

What is claimed is:

1. A bearing comprising:
an outer ring;
an inner ring;
a sensor; and
connecting material;
at least one of the outer ring or the inner ring is overmolded with the connecting material, at least a part of the senor is overmolded in the connecting material.

2. The bearing of claim 1, wherein the sensor is a vision sensor having:
a sensor body; and
a camera extending from the sensor body, the camera having a field of view towards an area to be sensed in the bearing.

3. The bearing of claim 2, further comprising a cage and rolling elements, wherein the outer ring has a first raceway, and the inner ring has a second raceway, wherein the area to be sensed covers at least one of the first raceway of the outer ring, the second raceway of the inner ring, the cage of the bearing, or the rolling elements.

4. The bearing of claim 2, wherein the vision sensor includes an adjusting member arranged between the sensor body and the camera, the adjusting member being configured to be adjusted to adjust the field of view of the camera.

5. The bearing of claim 4, wherein the sensor includes a transmission line between the sensor body and the camera, and wherein:
the adjusting member is a deformable sleeve, the transmission line being arranged in the deformable sleeve; or
the adjusting member is a wire wound around the transmission line.

6. The bearing of claim 5, wherein the adjusting member is the deformable sleeve, the transmission line being arranged in the deformable sleeve, the deformable sleeve having at least one of wear resistance, corrosion resistance, or high temperature resistance.

7. The bearing of claim 5, wherein the adjusting member is the wire wound around the transmission line, the wire having at least one of wear resistance, corrosion resistance, or high temperature resistance.

8. The bearing of claim 4, wherein the vision sensor further comprises an illuminator configured to emit illumination light toward the area to be sensed.

9. The bearing of claim 8, wherein the illuminator is integrated in the camera.

10. The bearing of claim 8, wherein the illuminator is independent of the camera, the illuminator having wires and an illuminator adjusting member arranged around the wires, the illuminator adjusting member being configured to adjust the illumination range of the illuminator.

11. The bearing of claim 1, wherein the sensor is an infrared temperature sensor having:
a sensor body; and
a photodetector head extending from the sensor body and disposed toward an area to be sensed in the bearing.

12. The bearing of claim 10, wherein the infrared temperature sensor has a transmission line between the sensor body and the photodetector head, wherein the infrared temperature sensor further has an adjusting member disposed around the transmission line, the adjusting member being configured to be adjusted to adjust the sensing position of the photodetector head.

13. The bearing of claim 12, wherein the adjusting member is a deformable sleeve, the transmission line being disposed in the deformable sleeve.

14. The bearing of claim 13, wherein the deformable sleeve has at least one of wear resistance, corrosion resistance, or high temperature resistance.

15. The bearing of claim 12, wherein the adjusting member is a wire wounded around the transmission line.

16. The bearing of claim 15, wherein the wire has at least one of wear resistance, corrosion resistance, or high temperature resistance.

17. The bearing of claim 1, wherein the sensor is a contact sensor.

18. The bearing of claim 17, wherein the contact sensor has a sensing component in direct contact with said at least one of the outer ring or the inner ring.

19. The bearing of claim 17, wherein the contact sensor is a contact temperature sensor or a contact vibration sensor.

20. The bearing of claim 1, wherein the sensor is a multifunctional sensor, the multifunctional sensor having at least two functions, the at least two functions being selected from the group consisting of temperature sensing, vibration sensing, and visual imaging.

21. The bearing of claim 1, wherein the connecting material is an insulating material.

22. The bearing of claim 21, wherein the sensor includes a sensor body, wherein:
the sensor body comprises a wireless communication module for emitting a sensing signal, the sensor body being separated from said at least one of the outer ring or the inner ring by the insulating material; and/or
the sensor body has an energy harvester and a rechargeable battery connected to the energy harvester, the energy harvester being configured to supply electrical energy to the rechargeable battery, the sensor having power consuming components, the rechargeable battery being configured to supply power to the power consuming components of the sensor.

23. The bearing of claim 21, wherein the sensor includes a sensor body, wherein the sensor body has an energy harvester and a rechargeable battery connected to the energy harvester, the energy harvester being configured to supply electrical energy to the rechargeable battery, the sensor having power consuming components, the rechargeable battery being configured to supply power to the power consuming components of the sensor, and wherein the sensor body also has a backup battery to supply power to the power consuming components of the sensor when the rechargeable battery is out of power or is malfunctioning.

24. The bearing of claim 1, wherein the sensor is overmolded on a circumferential face or either axial end face of said at least one of the outer ring or the inner ring.

25. The bearing of claim 24, wherein the sensor includes a sensor body, and wherein said at least one of the outer ring or the inner ring includes a groove for housing the sensor body of the sensor.
